(19) United States
(12) Patent Application Publication
(10) Pub. No.: US 2016/0041782 A1
(43) Pub. Date: Feb. 11, 2016

(54) Storage Device Copying of a larger system to a smaller system

(71) Applicant: Randall Deetz, Costa Mesa, CA (US)

(72) Inventor: Randall Deetz, Costa Mesa, CA (US)

(21) Appl. No.: 14/820,923

(22) Filed: Aug. 7, 2015

Related U.S. Application Data
(60) Provisional application No. 62/034,295, filed on Aug. 7, 2014.

(51) Int. Cl. G06F 3/06

(52) U.S. Cl. CPC G06F 3/0619; G06F 3/065; G06F 3/0683; G06F 3/0643

(57) ABSTRACT

Creating a cloned version of a system storage device that contains less capacity than the used space of the original system storage device and the means to prevent the user from making the cloned disk unbootable. A software program can run on a computer and a backup device such as a disk drive, thumb drive, or solid state drive. The software program sizes the minimum storage capacity needed and the user is allowed to select, through an interface, folders and files to not be copied. The software program will not allow the user to select any folders or files which would render the clone unbootable, including not allowing the user to select any folders or files contained in the windows® directory.

This application claims priority from provisional application number 62/034,295, filed Aug. 7, 2014, the entire contents of which are herewith incorporated by reference.

### FIELD OF INVENTION

This invention relates to the field of creating bootable storage devices on external storage devices of various media types.

### DISCLAIMER

The terms: Microsoft®, Windows NT®, Windows XP®, Windows Vista®, Windows 7®, and Windows 8® are registered trademarks of Microsoft Inc.

### BACKGROUND

Cloning of computer system disks is well known in the art. Cloning software has been available for tens of years and has evolved over the years as storage devices have evolved. Backup software systems from various manufactures have had the ability to create what is commonly referred to as bare metal backups. Most of these products will create a copy of the system drive resident in a computer that is used to rebuild a system disk from scratch and makes the new system drive bootable. Some products have the ability to use a storage device that is smaller than the system drive being backed up by compressing the data in the backup. These types of backups may not bootable. Some products give the user the ability to “groom” the data being backed up. A problem with these types of products is that most users are not sophisticated enough to select the data to be groomed out of the cloned storage device and many of the cloned storage devices end up not being bootable because the user selected folders and files for grooming that are needed for bootability.

### SUMMARY OF THE INVENTION

The inventors recognized the need for some way to automatically select folders and files for automatic grooming as part of the cloning process and if that does not sufficiently reduce the amount of data being cloned, then some additional way is needed to allow the user to select data for grooming and at the same time preventing the user from selecting data for grooming that will render the storage device non-bootable.

Embodiments describe methods for cloning a larger system storage device to a smaller storage device without losing the ability of booting from the smaller storage device and preventing the user from excluding data that would render the smaller storage device from booting.

### BRIEF DESCRIPTION OF THE DRAWINGS

FIG. 1 is a schematic representation of a personal computer with an attached storage device.

FIG. 2A-2E are lists of files needed for a bootable drive and lists of files that can be discarded without rendering a storage device unbootable.

FIG. 3 is a UML diagram showing the logic flow during execution of the invention for a preferred embodiment where the user selects sets of folders and files for exclusion and where the invention prevents the user from excluding folders and files critical for booting.

FIG. 4 is a UML diagram showing the logic flow of the invention for another preferred case where the invention will automatically exclude all non-critical folders and files not needed for booting except for user's files.

FIG. 5 is a UML diagram showing the logic flow of the invention for another preferred embodiment for automatically creating a bootable attached storage device with the operating system and all software program applications and no user data files or temporary files without user intervention.

FIG. 6 is a UML diagram showing the logic flow of the invention for another preferred embodiment for automatically creating a bootable attached storage device with the operating system and all software program applications. This embodiment will attempt to add back the maintenance and hidden partitions if sufficient capacity is available completely without user intervention.

FIG. 7 is a UML diagram showing the logic flow of a callable function which checks to see if one or more partitions have been excluded and if they the external storage device will be updated to reflect the absence of the excluded partitions.

FIG. 8 is a UML diagram showing the logic flow of a callable function which excludes non-critical system data objects such as recycle bins, all partitions except partition 1, and all user documents in the users library.

FIG. 9 is a UML diagram showing the logic flow of a callable function which copies all non-excluded data object from the internal system storage 22 to the external storage device 30.

FIG. 10 is a UML diagram showing the logic flow of a callable function which displays a list of all excludable data objects and includes check boxes next to each data object. This allows the user to mark data objects for exclusion.

FIG. 11 is a logic flow chart that depicts a callable function which computes the used capacity of internal system storage 22 less any excluded data objects such as maintenance partitions, hidden partitions, user libraries and other excluded data objects. The function then compares the non-excluded used area with the capacity of external storage device 30. If the non-excluded used area of internal system storage 22 is less than the capacity of external storage device 30, the function returns a YES to the caller otherwise the function returns a NO to the caller.

FIG. 12 is a logic flow chart that depicts a callable function which excludes any maintenance and hidden partitions and checks to see if the computed size of internal system storage 22 is less than the capacity of external storage device 30. If the computed size of internal system storage 22 is less than external storage device 30, the function returns a YES to the caller otherwise it returns a NO to the caller.

FIG. 13 is a logic flow chart that depicts a callable function which excludes temp folders and files and empties all of the recycle bins then checks to see if the computed size of internal system storage 22 is less than the capacity of external storage device 30. If the computed size of internal system storage 22 is less than external storage device 30, the function returns a YES to the caller otherwise it returns a NO to the caller.

### DETAILED DESCRIPTION

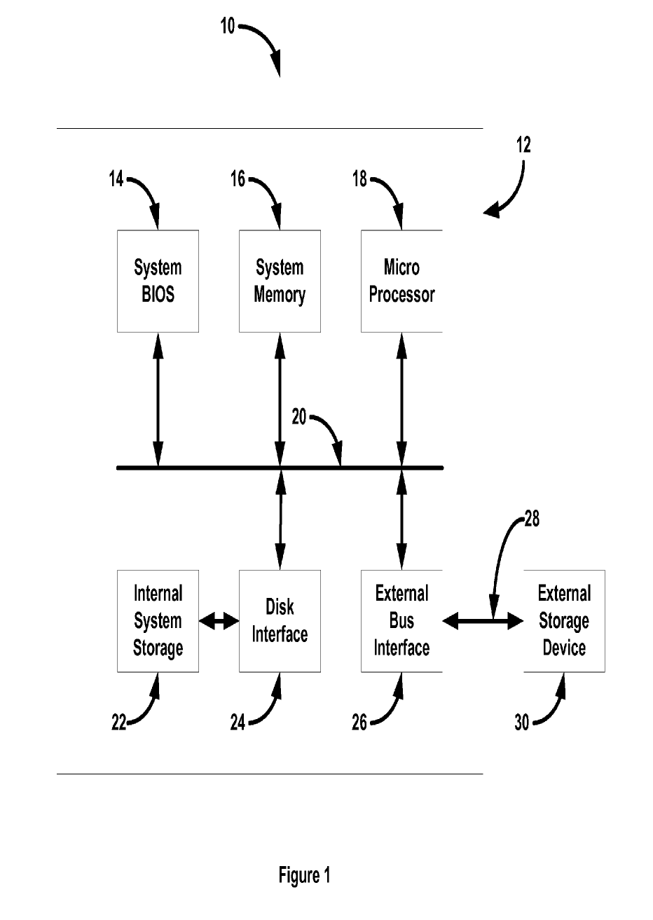

Now referencing FIG. 1 where 10 depicts a schematic of a typical personal computer that the invention could be executed on. In this depiction, personal computer 12 may be a desktop computer, a laptop computer, a tablet computer, PDA, game console, cell phone or any other personal computing system where internal and external storage may be resident. In depiction 10, personal computer 12 contains system BIOS 14. System BIOS 14 is comprised of a flash memory device containing a set of computer codes which has knowledge of where the operating system resides on internal system storage 22 and among other codes has knowledge of devices attached to external bus 28. System BIOS 14 is a typical PC system BIOS that has the capability of detecting the failure of the operating system residing on internal system drive 22 during the boot process. If a failure to boot is detected, system BIOS 14 computer codes 1 scan a table internal to system BIOS 14 and verify whether there is another storage device, either internal or external to personal computer 12, that is present and if one is present and contains a resident operating system, system BIOS 14 will attempt to boot that operating system. Personal computer 12 also contains system memory 16 which contains computer codes and data such as the operating system, application programs, and other such data.

Personal computer 12 may, instead of having a typical BIOS may instead have a UEFI (Unified Extensible Firmware Interface). This type of device is meant to replace the Basic Input/Output System (BIOS) firmware interface, originally present in all IBM PC-compatible personal computers. In practice, most UEFI images provide legacy support for BIOS services. UEFI can support remote diagnostics and repair of computers, even without another operating system.

Personal computer 12 also contains microprocessor 18 which executes software residing in system BIOS 14 and system memory 18. Personal computer 12 also contains a storage system consisting of disk interface 24 and internal system storage 22. Disk interface 24 receives commands from microprocessor 18 in the form of reads and writes to internal system drive 22. Internal system drive 22 holds software programs and data. Internal system storage 22 may be any storage device such as rotating magnetic disk drives or solid state drives composed of flash memory devices. Personal computer 12 also supports an external storage system composed of external bus interface 26 and external storage device 30. External bus interface 26 communicates with external storage device 30 over external bus 28. External bus 28 may be any external bus including USB, Firewire, SCSI, wired Ethernet, or any wired or wireless bus.

The invention can include executable code such as firmware or software on internal system storage 22 and be read from internal system storage 22 into system memory 16 by microprocessor 18 which then executes the computer code.

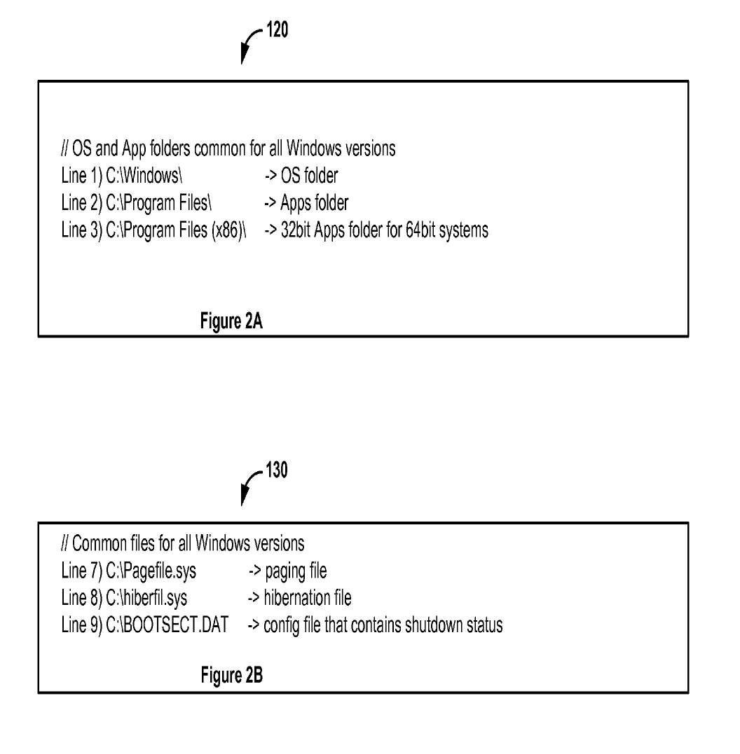

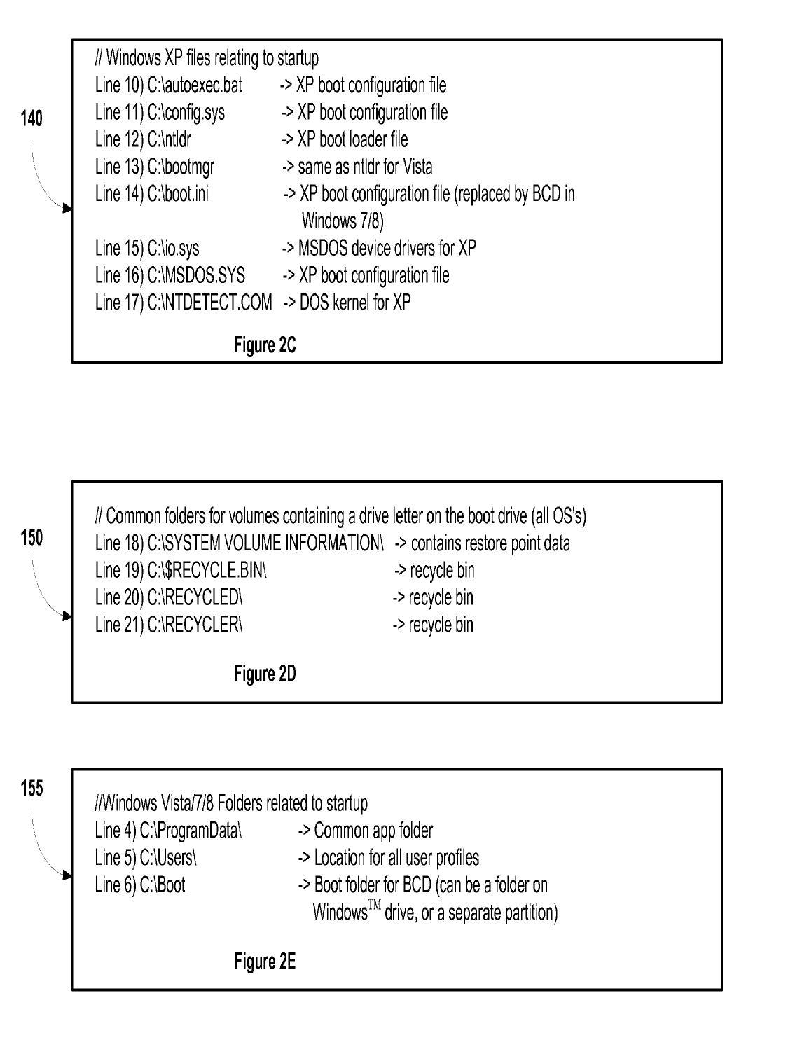

Now referencing FIGS. 2A, 2B, 2C, and 2D which represent lists of folders and files necessary for making a storage device bootable and sets of folders and files which are not necessary for making a storage device bootable. Note that none of the four lists contain user folders or files.

Now referencing FIG. 2A where 120 is a list of folders and files necessary for bootability of a storage device. Note that there is a comment line “//” shown at the top of the figure that acts as a title for the figure. Also note that line numbers are used to identify each of the folders or files that make up the listing.

FIG. 2A is a list of common operating system and application program folders and files. In this figure, line 1 is the folder that contains the operating system for Microsoft Windows® operating system. FIG. 2A only relates to the operating system Windows XP® systems. The folder will contain subfolders and files.

Line 2 of FIG. 2A is the folder that contains the software program applications. This folder will typically hold the application program files that are designed to run on a 64 bit operating system.

Line 3 of FIG. 2A is the folder that contains a class of software program application files designed to run on a 32 bit operating system. Microsoft Windows® operating systems are either 32 bit or 64 bit systems. If the operating system for a given personal computer is 64 bit, all 32 bit software program applications are segregated to a specified folder (C:\Program Files (x86)) and when executed by the 64 bit operating system are run in a special mode for 32 bit software program applications.

All of the folders and files listed in FIG. 2A are necessary for bootability for many internal or externally attached storage devices.

Now referencing FIG. 2B where 130 is a list of folders and files that are common for all versions of Microsoft Windows® starting with Windows XP®, Windows Vista®, Windows 7®, and Windows 8®.

Line 7 of FIG. 2B is Pagefile.sys file. Pagefile is the software manager that allows a computer to store and retrieve data from secondary storage for use in main memory. In the paging memory-management scheme, the operating system retrieves data from secondary storage in same-size blocks called pages. This gives the operating system an advantage over memory segmentation in that it allows the physical address space of a process to be noncontiguous. Before paging came into use, systems had to fit whole programs into storage contiguously, which caused various storage and fragmentation problems. Paging is an important part of virtual memory implementation in most contemporary general-purpose operating systems, allowing them to use disk storage for data that does not fit into physical random-access memory (RAM).

Line 8 of FIG. 2B shows “hiberfil.sys” which is the hibernation file. This file is, as shown in line 8 of FIG. 2B in the “root” of the system storage device. This file is used when the user puts the computer into “hibernation”. When this event takes place the contents of system memory along with other data is copied to hiberfil.sys. Note that not all computers will require these files, and/or may have other files with comparable attributes, for example.

Line 9 of FIG. 2B shows “BOOTSECT.DAT” which is a configuration file that is primarily used for dual-booting systems. If you allow this file to be excluded, then the dual boot capability of the target drive will not function. Bootsect.dat is actually a copy of the bootstrap contained on the active boot volume.

Now referencing FIG. 2C where 140 is a list of folders and files that are specific to Microsoft Windows XP®.

Line 10 of FIG. 2C shows the Windows XP® boot configuration file. Autoexec.bat is read upon startup by all versions Windows® up to Windows XP®. Autoexec.bat is most often used to set environment variables such as keyboard, soundcard, printer, temporary file locations and used to initiate low level system utilities

Line 11 of FIG. 2C shows the config.sys. For dual booting systems (DOS and Windows®) autoexec.bat and config.sys are renamed autoexec.dos and config.dos when booting windows and autoexec.bat and config.sys when booting DOS. They only exist to provide backwards compatibility with legacy software.

Line 12 of FIG. 2C shows the ntldr file which is the Windows® boot loader for all releases of Windows NT operating system up to and including Windows XP®. NTLDR is typically located and run from the primary hard disk drive, but it can also run from portable storage devices such as a CD-ROM, USB flash drive, or floppy disk. NTLDR requires, at the minimum, the following two files to be on the system volume, those being ntldr, the main boot loader itself and NTDETECT.COM, required for booting an NT®-based OS, detects basic hardware information needed for successful boot.

Line 13 of FIG. 2C shows the bootmgr file which controls the boot process for Windows® version after Windows XP®.

Line 14 of FIG. 2C shows the boot.ini file. NTLDR's first action is to read the boot.ini file. NTLDR allows the user to choose which operating system to boot from at the menu. For NT® and NT®-based operating systems, it also allows the user to pass preconfigured options to the kernel. The menu options are stored in boot.ini, which itself is located in the root of the same disk as NTLDR.

Line 15 of FIG. 2C shows the io.sys file. This file is executed as part of the boot process. IO.SYS is an essential part of Windows XP®. The two first entries of the root directory must be allocated by IO.SYS and MSDOS.SYS, in that order. IO.SYS must be the first file stored in the data storage area for files. The files IO.SYS+MSDOS.SYS must be contiguous

Line 16 of FIG. 2C shows the MSDOS.SYS file. This file is an important system file on MS-DOS and Windows NT® systems. It is loaded by IO.SYS. MSDOS.SYS is ASCII file containing boot configuration directives. By default, the file is located in the root directory of the bootable drive/partition and has the hidden, read-only, and system file attributes set. Windows XP® uses the NTLDR file and Windows Vista®, Windows 2008®, and Windows 7® uses bootmgr instead, as they have a different boot sequence.

Line 17 of FIG. 2C shows the NTDETECT.COM file. This file is a component of Microsoft Windows NT®-based operating systems such as Windows XP® that operate on the x86 architecture. It is used during the Windows NT® startup process, and is responsible for detecting basic hardware that will be required to start the operating system.

Now referencing FIG. 2D which shows a list of folders for volumes containing a drive letter. All bootable volumes contain a drive letter identifier.

Line 18 of FIG. 2D shows the SYSTEM VOLUME INFORMATION folder. This folder contains restore point data for the system allowing the user to backup to a previous version of the operating system and software program applications.

Line 19 of FIG. 2D shows the $RECYCLE.BIN folder. This folder contains the Recycled” folders for all users. When any user deletes a file or folder in Windows Explorer or My Computer, the file is stored in the Recycle Bin. The file remains in the Recycle Bin until you empty the Recycle Bin or restore the file.

Line 20 of FIG. 2D shows the RECYCLED folder. This folder is used with FAT formatted volumes on Windows XP™ and prior, Definition from Microsoft™—“The Recycled folder contains a Recycle Bin for each user that logs on to the computer, sorted by their security identifier (SID)” This basically allows different user to have their own recycle bin.

Line 21 of FIG. 2D shows the RECYCLER folder. This folder is used with NTFS formatted volumes on Windows XP and above, Definition from Microsoft™—“The Recycled folder contains a Recycle Bin for each user that logs on to the computer, sorted by their security identifier (SID)” This basically allows different user to have their own recycle bin.

Now referencing FIG. 2E which shows a list of folders for Windows Vista, Windows 7, and Windows 8™ volumes that are necessary for making bootable drives and partitions.

Line 4 is the name of the common applications folder for 64 bit operating systems.

Line 5 is the name of the folder that contains all of the user profiles.

Line 6 is the name of the boot folder for BCD bootable drives or partitions.

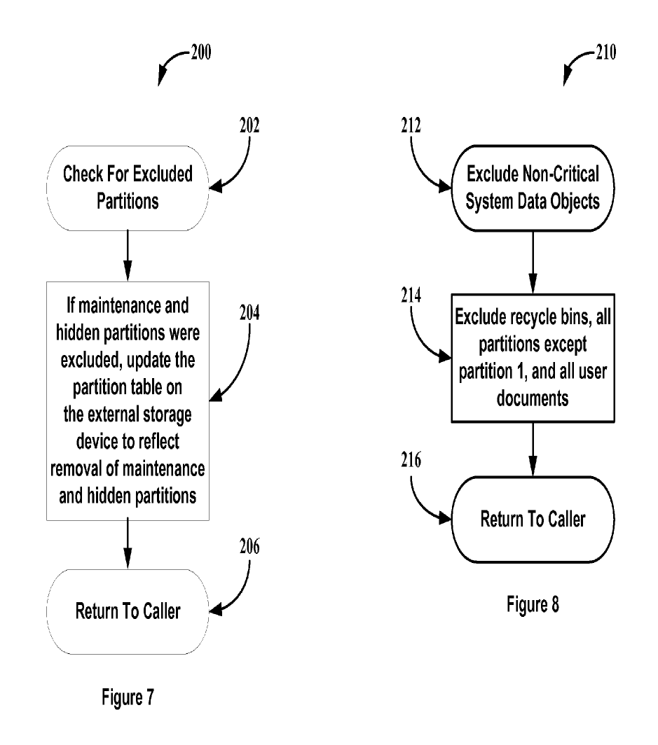

Now referencing FIG. 7 which is a callable function. Check for excluded partitions 200 is entered through entry block 202 where control falls through to logic block 204. This logic block checks to see if maintenance partitions, hidden partitions or any other partition other than the boot or system partition was excluded. If partitions other than the boot and system partition were removed, then the partition table residing on external storage device 30 will be updated to reflect the removed partitions. After logic block 204 has executed, control will fall through to exit block 206 return to caller where control is transferred back to the calling function.

Now referencing FIG. 8 which is a callable function. Exclude non-critical system data objects 210 is entered through entry block 212 where control falls through to logic block 214. This logic block excludes recycle bins, all partitions listed in the partition table with the exception of the boot and system partitions and all user libraries, folders, and files are excluded. After logic block 214 has executed, control will fall through to exit block 216 return to caller where control is transferred back to the calling function.

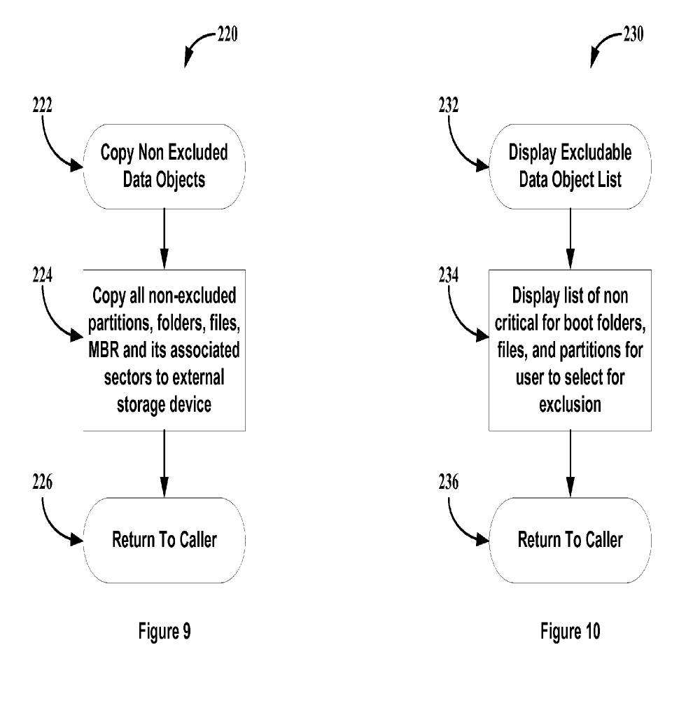

Now referencing FIG. 9 which is a callable function. Copy non excluded data objects 220 is entered through entry block 222 where control falls through to logic block 224. This logic block copies all non-excluded partitions, folders, files, and boot sectors to external storage device 30. At this point external storage device 30 will be bootable.

Now referencing FIG. 10 which is a callable function. Display Excludable Data Object List is entered through entry block 230 where control falls through to logic block 232. This logic block copies all non-excluded partitions, folders, files, and boot sectors to external storage device 30.

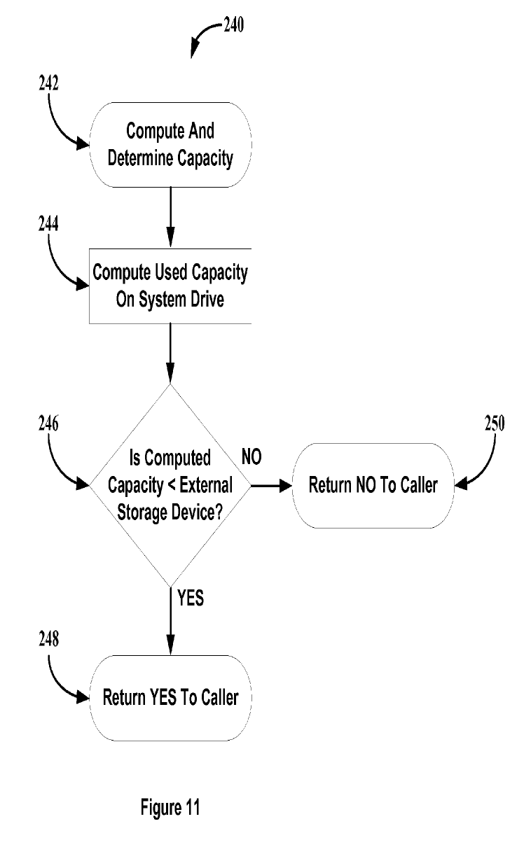

Now referencing FIG. 11 which is a callable function. Compute and determine capacity 240 is entered through entry block 242 where control falls through to logic block 244. This logic block will compute the non-excluded used capacity of internal system storage 22 after which control will fall through to decision block 244 Is Computed Capacity<External Storage Device?. If the computed non-excluded capacity of internal system storage is less than the capacity of external storage device 30, control will be transferred to exit block 250 return NO to caller. If the computed non-excluded capacity of internal system storage is greater than the capacity of external storage device 30, control will be transferred to exit block 248 return Yes to caller.

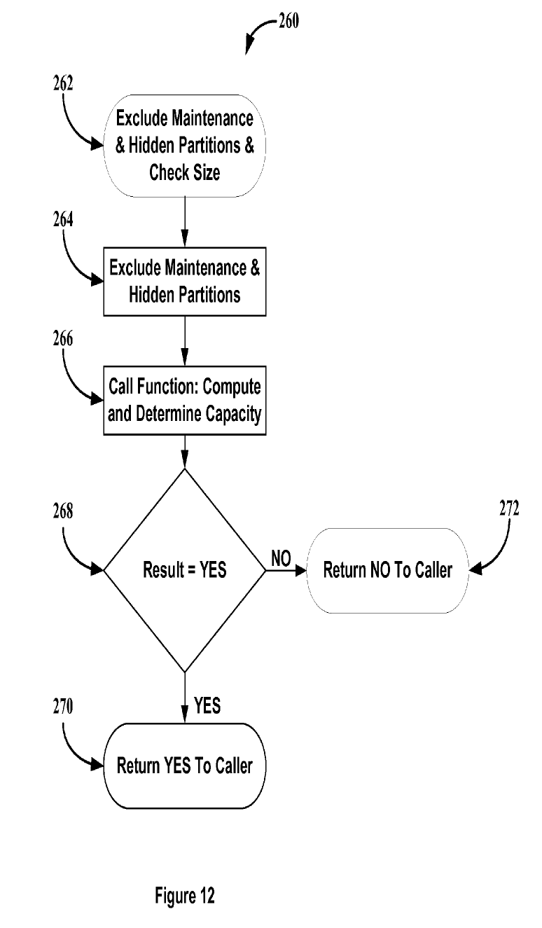

Now referencing FIG. 12 which is a callable function. Exclude Maintenance & Hidden Partitions & Check Size is entered through entry block 262 where control falls through to logic block 264. This logic block excludes any maintenance partitions and hidden partitions after which a call to function: compute and determine capacity which will return a “YES” if the remaining used capacity of internal system storage is less than the capacity of external storage device 30 or it will return a “NO” if the remaining used capacity of internal system storage is more than the capacity of external storage device 30. These return states are then returned to the caller of this function.

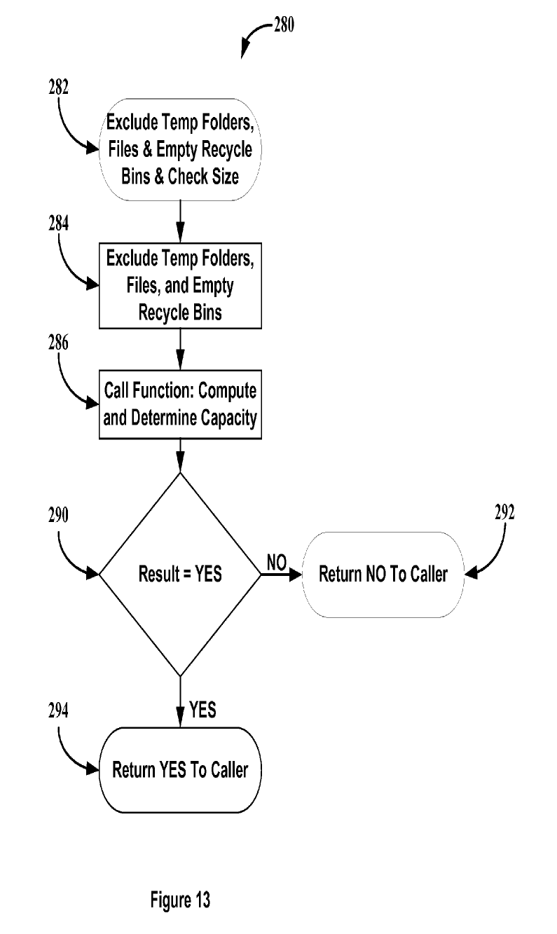

Now referencing FIG. 13 which is a callable function. Exclude Temp Folders and Empty Recycle Bins and Check Size is entered through entry block 282 where control falls through to logic block 284. This logic block excludes all of the temporary folders and files on internal system storage 22. These folders and files are typically saved files from internet browsers and other temporary files from applications processing. After the temporary folders and files have been excluded, the recycle bins are excluded after which a call to compute and determine capacity is made to check to see if the newly computed size of internal system storage 22 is less than the available capacity on external storage device 30. If the computed size of internal system storage 22 is less than the available capacity on external storage device 30, this function will return YES to the caller other wise it will return NO to the caller.

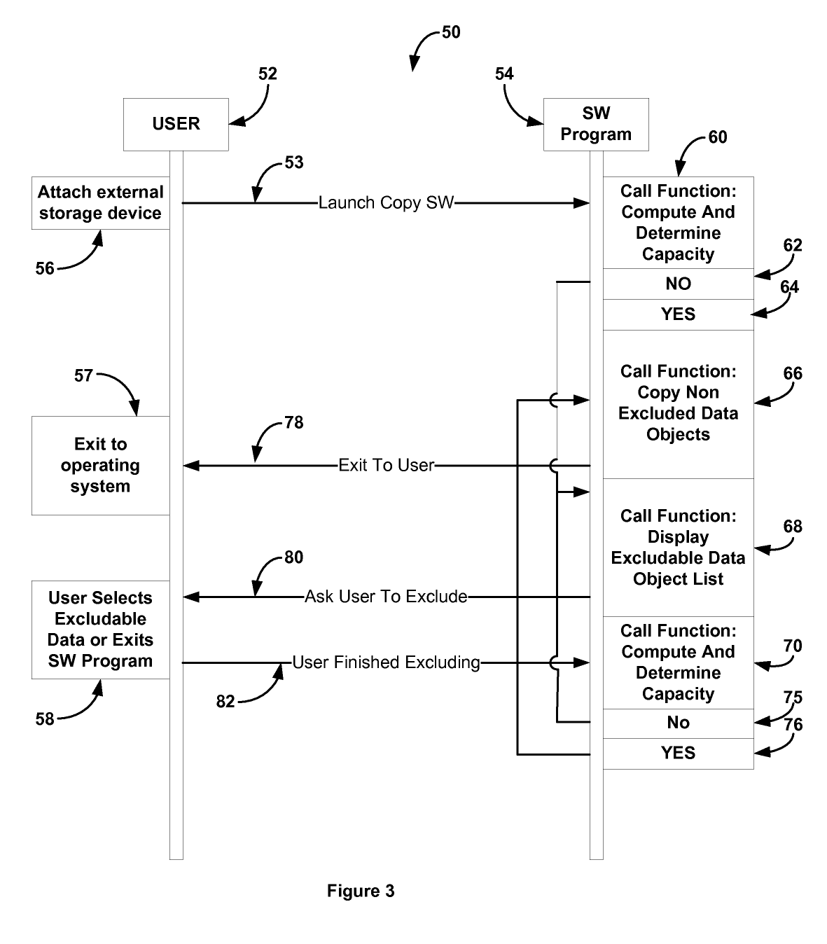

Now referencing FIG. 3 where 50 depicts one embodiment of the invention. In this embodiment if the size of the external storage device is not large enough to contain all of the partitions, folders, and files on the system drive, the invention allows the user to pick the partitions, folders, and files to exclude from the copy process. In this embodiment, the invention will not allow the user to exclude any partitions, folders, and files critical to the booting process.

In this embodiment, the user 52 at logic block 56 attach external storage device will attach external storage device 30 to personal computer 12 thorough external bus 28. User 52 will then launch copy software 53 which causes the operating system of personal computer 12 to start execution of SW program 54. SW Program 54 starts execution at logic block 60 call function: compute and determine capacity. This function is shown in FIG. 11, 240. If the size of internal system storage 22 is less than the capacity of external storage device 30, the function will return “YES” otherwise the function will return “NO”.

If “NO” is returned, control will be transferred to logic block 68 call function: Display excludable data object list. This function is shown in FIG. 10, 230.

If “YES” is returned, it means that the capacity of internal system storage 22 is less than the capacity of external storage device 30. Control will fall through to logic block 66 call function: copy non-excluded data objects. This function is shown in FIG. 9, 220. This function will copy all data object blocks residing on internal system storage 22 which will make external storage device 30 bootable. When this function passes control back to logic block 66, logic block 66 will send notification 78 exit to user to logic block 57 exit to operating system.

If the result of logic block 60′s function call returned “NO” 62, control will be transferred to logic block 68 call function: display excludable data object list. This function is shown in FIG. 10, 230. This function displays a dialog to user 52. The dialog is a list of excludable data objects that are not critical for making external storage device 30 bootable. The list can be set as groups of files, e.g., partitions, folders, file types or others.

Logic block 68 is the first logic block in a loop which runs until the user has either selected a sufficient number of non-excluded data objects to be excluded or the user exits SW program 54. The look consists of logic blocks 68, notification 80, logic block 58, notification 82, logic block 70 and return states 75 and 76.

Start of loop:

Logic block 68 calls function: display excludable data object list. When function 239 returns control to logic block 68, logic block 68 will send notification 80 ask user to exclude to logic block 58. Logic block 58 waits for the user to either select one or more items from the excludable list or selects to exit SW program 54. If the user has selected one or more data objects to exclude, logic block 558 will send notification 82 user finished excluding to logic block 70 call function: compute and determine capacity. If function 240 returns “YES” indicating that the used area of internal system storage 22 is smaller than external storage device 30, control will be transferred to logic block 66 call function: copy non excluded data objects. This function is shown in FIG. 9, 220. After all non-excluded data objects have been copied to external storage device 30 control will be transferred back to logic block 66 after which logic block 66 will send notification 78 exit to user to logic block 57 exit to operating system.

If function 240 returned “NO” to logic block 70, control will be transferred to logic block 68 call function: display excludable data object list which is the first logic block in the loop described above.

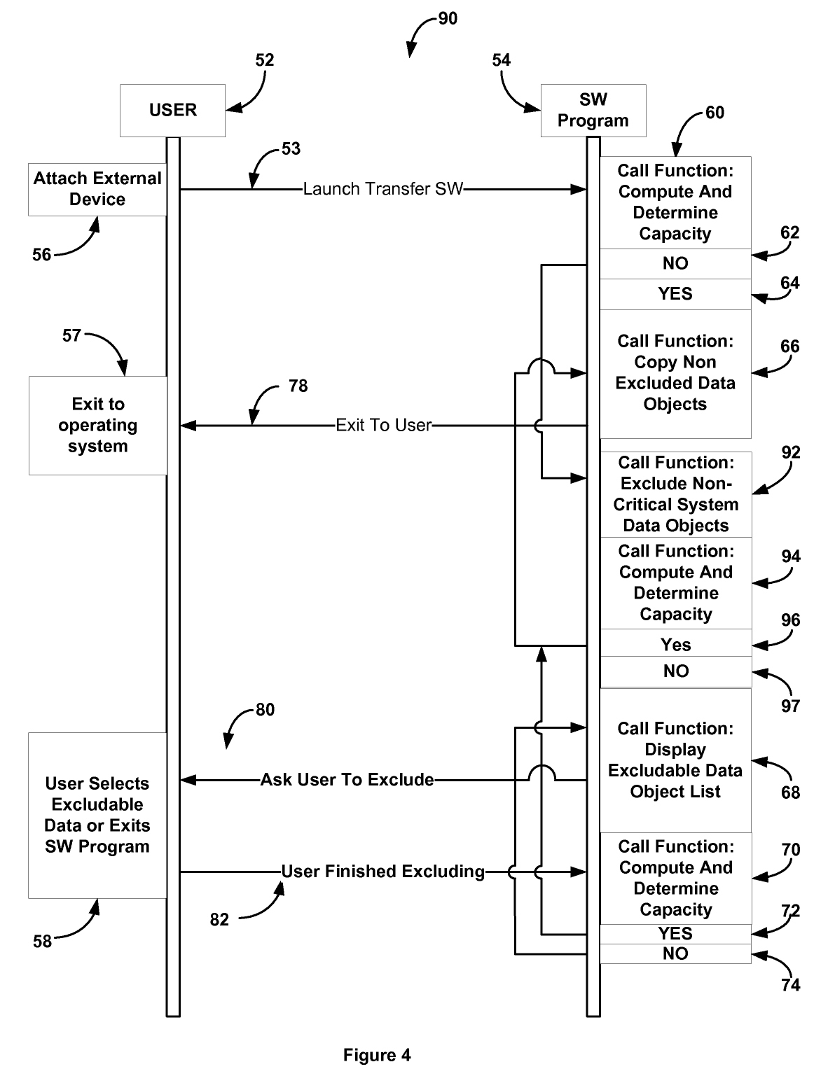

Now referencing FIG. 4 where 90 depicts one embodiment of the invention. In this embodiment if the size of the external storage device is not large enough to contain all of the partitions, folders, and files on internal system storage the invention will automatically exclude partitions, folders, and files not necessary for making eternal storage device 30 bootable. In this embodiment the invention will exclude data objects such as maintenance partitions, hidden partitions, recycle bins, and any temporary folders and files such as internet files and left over install files that are no longer needed. If the size of the remaining data objects still exceeds the capacity of the external storage device, the invention will give the user the opportunity to manually exclude non-critical data objects. In this embodiment, the invention will not let the user exclude any partitions, folders, and files critical to the booting process.

In this embodiment, the user 52 at logic block 56 attach external storage device will attach external storage device 30 to personal computer 12 thorough external bus 28. User 52 will then launch transfer software 53 which causes the operating system of personal computer 12 to start execution of SW program 54. SW program 54 starts execution at logic block 60 call function: compute and determine capacity which is shown in FIG. 11, 240. If the size of internal system storage 22 is less than the capacity of external storage device 30, the function will return “YES” otherwise the function will return “NO”.

If “NO” is returned, control will be transferred to logic block 92 call function: exclude non-critical data objects. This function is shown in FIG. 8, 210.

If “YES” is returned, it means that the capacity of internal system storage 22 is less than the capacity of external storage device 30. Control will fall through to logic block 66 call function: copy non-excluded data objects. This function is shown in FIG. 9, 220. This function will copy all data object blocks residing on internal system storage 22 which will make external storage device 30 bootable. When this function passes control back to logic block 66, logic block 66 will send notification 78 exit to user to logic block 57 exit to operating system.

If “NO” 62 had been returned to logic block 60, control will be transferred to logic block 92 call function” exclude non-critical system data objects. This function is shown in FIG. 8, 210. Function 210 excludes all non-critical system data objects. When control is returned to logic block 92, control will fall through to logic block 94 call function: compute and determine capacity. If “YES” 96 was returned it means that the used capacity of internal system storage less the excluded data objects is less than the capacity of external storage device 30 and control will be transferred to logic block 66 call function: copy non excluded data objects.

If “NO” 97 had been returned control will fall through to logic block 68 call function: display excludable data object list. This function is shown in FIG. 10, 230. This function displays a dialog to user 52. The dialog is a list of excludable data objects that are not critical for making external storage device 30 bootable.

Logic block 68 is the first logic block in a loop which runs until the user has either selected a sufficient number of non-excluded data objects to be excluded or the user exits SW program 54. The loop consists of logic block 68, notification 80, logic block 58, notification 82, logic block 70 and return states 75 and 76.

Start of Loop:

Logic block 68 calls function: display excludable data object list. When function 239 returns control to logic block 68, logic block 68 will send notification 80 ask user to exclude to logic block 58. Logic block 58 waits for the user to either select one or more items from the excludable list or selects to exit SW program 54. If the user has selected one or more data objects to exclude, logic block 58 will send notification 82 user finished excluding to logic block 70 call function: compute and determine capacity. If function 240 returns “YES” indicating that the used area of internal system storage 22 is smaller than external storage device 30, control will be transferred to logic block 66 call function: copy non excluded data objects. This function is shown in FIG. 9, 220. After all non-excluded data objects have been copied to external storage device 30 control will be transferred back to logic block 66 after which logic block 66 will send notification 78 exit to user to logic block 57 exit to operating system.

If function 240 returned “NO” to logic block 70, control will be transferred to logic block 68 call function: display excludable data object list which is the first logic block in the loop described above.

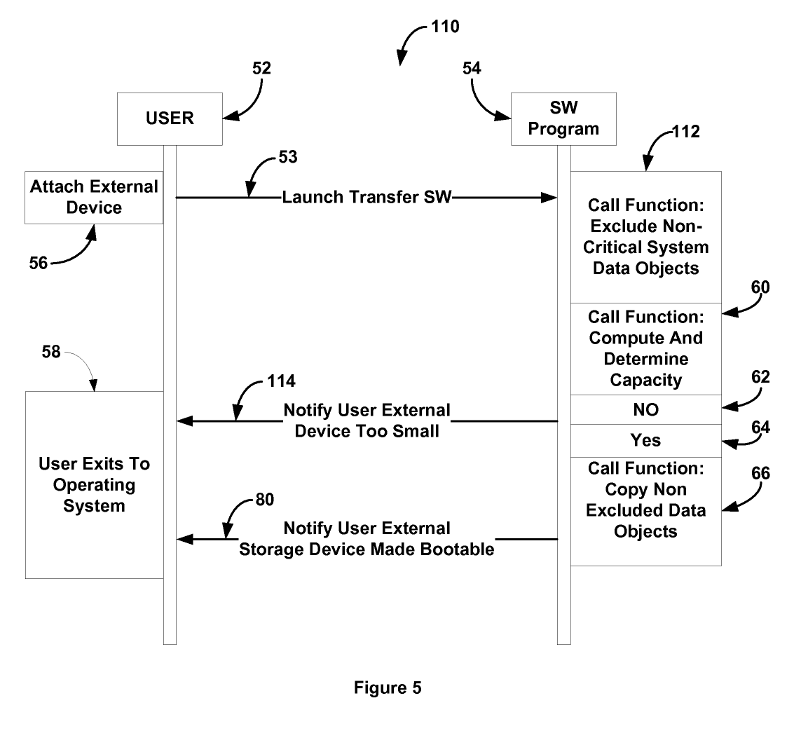

Now referencing FIG. 5 where 110 depicts one embodiment of the invention. In this embodiment an attempt will be made to make external storage device 30 a minimal bootable device. SW program 54 will exclude all non-critical system data objects then check to see if the used capacity less excluded data objects is less than the capacity of external storage device 30. If it is, the non-excluded data objects will be copied to external storage device 30 making the device bootable. If internal system storage 22 is not smaller than external storage device 30, the user will be notified.

In this embodiment, the user 52 at logic block 56 attach external storage device will attach external storage device 30 to personal computer 12 thorough external bus 28. User 52 will then launch transfer software 53 which causes the operating system of personal computer 12 to start execution of SW program 54. SW program 54 starts execution at logic block 112 call function: exclude non-critical system data objects. This function is shown at FIG. 8, 210. After all non-critical data objects have been excluded control will be transferred back to logic block 112 and control will fall thought to logic block 60 call function: compute and determine capacity which is shown in FIG. 11, 240. If the size of internal system storage 22 is less than the capacity of external storage device 30, the function will return “YES” otherwise the function will return “NO”.

If the return is “NO” 62, notification 114 will be sent to logic block 58 user exits to operating system.

If the return is “YES” 64, control will fall through to logic block 66 call function: copy non excluded data objects. This function is shown in FIG. 9, 220. This function will copy all data object blocks residing on internal system storage 22 which will make external storage device 30 bootable. When this function passes control back to logic block 66, logic block 66 will send notification 80 notify user external storage device made bootable to logic block 58 user exits to operating system.

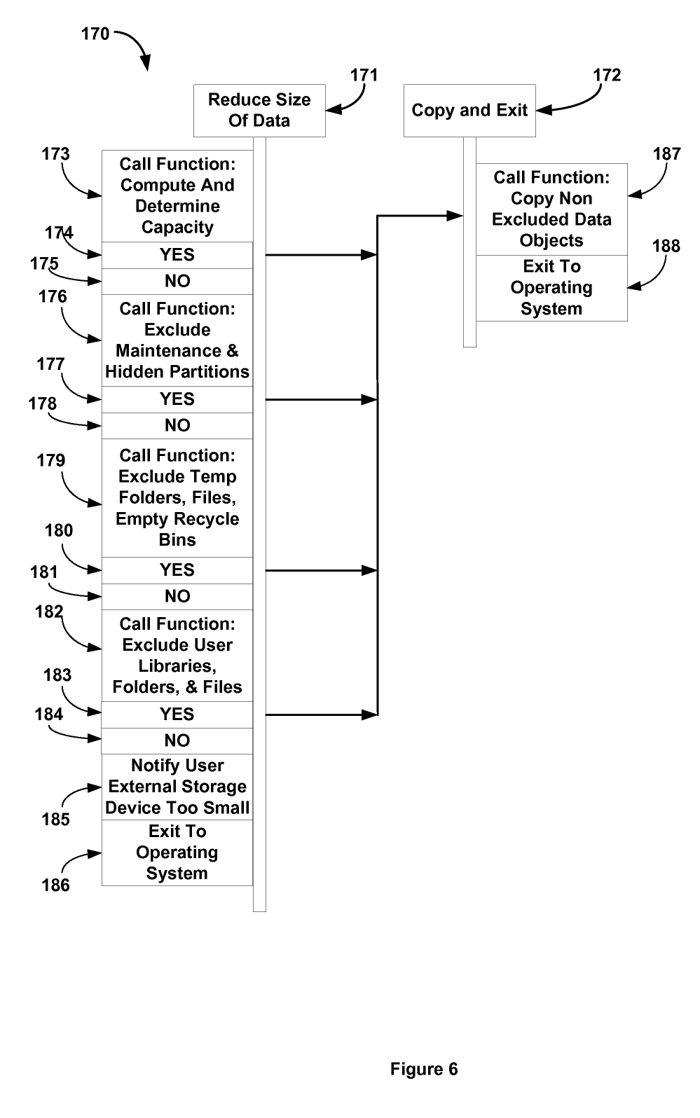

Now referencing FIG. 6 where 170 depicts one embodiment of the invention. In this embodiment if the size of the external storage device is not large enough to contain all of the partitions, folders, and files on the system drive the invention allows the user to pick the partitions, folders, and files to exclude from the copy process. In this embodiment, the user has no options for excluding any data objects from internal system storage 22. This embodiment is entirely automatic and results in either external storage device 30 being bootable or the user being notified that external storage device 30 is too small for even a minimal boot storage device.

In this figure, the process for 170 starts with logic block 173 call function: compute and determine capacity. If the return to the call is YES this means that the computed size of partition 1 with all of the critical and non-critical folders and files are smaller or equal to the available size of the external storage device 30. In this case, control will be transferred to logic block 174 and after which control will be transferred to logic block 187 call function: copy non excluded data objects. After control is transferred back to logic block 187 from the called function control will fall through to logic block 188 exit to operating system. At this point external storage device 30 is bootable.

If the return to logic block 173 from the called function was NO, this means that the computed size of partition 1 with all of the critical and non-critical folders and files is not smaller or equal to the available size of the external storage device 30. In this case, control will fall through to logic block 175 after which control will fall through to logic block 176 call function: exclude maintenance and hidden partitions. If the return from the called function is YES, this means that that the computed size of partition 1 with all of the critical and non-critical folders and files are smaller or equal to the available size of the external storage device 30. In this case, control will be transferred to logic block 177 after which control will be transferred to logic block 187 call function: copy non excluded data objects.

If the return to logic block 176 from the called function was NO, this means that the computed size of partition 1 with all of the critical and non-critical folders and files is not smaller or equal to the available size of the external storage device 30. In this case, control will fall through to logic block 178 after which control will fall through to logic block 179 call function: temp folders, files, and empty recycle bins. If the return from the called function is YES, this means that that the computed size of partition 1 with all of the critical and non-critical folders and files are smaller or equal to the available size of the external storage device 30. In this case, control will be transferred to logic block 180 and after which control will be transferred to logic block 187 call function: copy non excluded data objects.

If the return to logic block 179 from the called function was NO, this means that the computed size of partition 1 with all of the critical and non-critical folders and files is not smaller or equal to the available size of the external storage device 30. In this case, control will fall through to logic block 181 after which control will fall through to logic block 182 call function: exclude user libraries, folders, and files. If the return from the called function is YES, this means that that the computed size of partition 1 with all of the critical and non-critical folders and files are smaller or equal to the available size of the external storage device 30. In this case, control will be transferred to logic block 183 and after which control will be transferred to logic block 187 call function: copy non excluded data objects.

If the return to logic block 182 from the called function was NO, this means that the computed size of partition 1 with all of the critical and non-critical folders and files is not smaller or equal to the available size of the external storage device 30. In this case, control will fall through to logic block 184 after which control will fall through to logic block 185 notify user external storage device too small after which control will fall through to logic block 186 exit to operating system. If the return from the called function was YES, this means that that the computed size of partition 1 with all of the critical and non-critical folders and files are smaller or equal to the available size of the external storage device 30. In this case, control will be transferred to logic block 183 and after which control will be transferred to logic block 187 call function: copy non excluded data objects.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other techniques of synchronization can be used. For example while the figures show certain files and file names, other files/names can be used. FIG. 7 shows file closing events and file deleting events causing the file to be changed on the duplicate partition, this can be done at time intervals instead. For example, other techniques of synchronization can be used. For example while the figures show certain files and file names, other files/names can be used. Also other operating systems can be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of copying contents of a storage device from a first storage device to a second storage device, the method comprising:
using a computer for computing a used capacity of the first storage device and for computing an available capacity of the second storage device;
using the computer for determining if the used capacity of the first storage device is smaller than the available capacity of the second storage device;
if the used capacity of the first storage device is smaller than the available capacity of the second storage device, then copying all of folders and files and a master boot record and its associated sectors from the first storage device to the second storage device rendering the second storage device bootable;
if the used capacity of the first storage device is larger than the capacity of the second storage device, then:
displaying a selection list to a user where the selection list has names of user's folders and files and names of all system related folders and files not critical to the rendering of the second storage device bootable, and
prompting the user to select items from the selection list to be excluded from being transferred from the first storage device to the second storage device, and
after the user selects the items, again computing of the used capacity of the first storage device less the size of those folders and files selected for exclusion by the user, and determining using the computer if the new computed size of the first storage device is smaller than the available capacity of the second storage device, and copying all of the folders and files and master boot record and its associated sectors from the first storage device to the second storage device rendering the second storage device bootable, and
if the new computed size of the first storage device is larger than the capacity of the second storage device, allowing the user to either repeat the exclusion of folders and files or to exit.

2. The method as in claim 1, wherein the items are groups of files.

3. The method as in claim 1, wherein, if the used capacity of the first storage device is larger than the capacity of the second storage device, then automatically excluding certain files from being copied.

4. The method as in claim 3, wherein the certain files which are excluded from being copied include all of maintenance partitions, recycle bins, temporary folders and files and left over install files.

5. A computer system programmed for copying contents of a storage device from a first storage device to a second storage device, comprising:
a processor, programmed for computing a used capacity of the first storage device and for computing an available capacity of the second storage device, and
for determining if the used capacity of the first storage device is smaller than the available capacity of the second storage device;
said processor operating, if the used capacity of the first storage device is smaller than the available capacity of the second storage device, for copying all of the folders and files and a master boot record and its associated sectors from the first storage device to the second storage device rendering the second storage device bootable;
said processor operating, if the used capacity of the first storage device is larger than the capacity of the second storage device, for:
displaying a selection list to a user where the selection list has names of user's folders and files and names of all system related folders and files not critical to the rendering of the second storage device bootable, and
prompting the user to select items from the selection list to be excluded from being transferred from the first storage device to the second storage device, and
after the user selects the items, again computing of the used capacity of the first storage device less the size of those folders and files selected for exclusion by the user, and determining using the computer if the new computed size of the first storage device is smaller than the available capacity of the second storage device, and copying all of the folders and files and master boot record and its associated sectors from the first storage device to the second storage device rendering the second storage device bootable, and
if the new computed size of the first storage device is larger than the capacity of the second storage device, allowing the user to either repeat the exclusion of folders and files or to exit.

6. The system as in claim 5, wherein the items are groups of files.

7. The system as in claim 5, wherein, the computer operates, if the used capacity of the first storage device is larger than the capacity of the second storage device, for automatically excluding certain files from being copied.

8. The system as in claim 7, wherein the certain files which are excluded from being copied include all of maintenance partitions, recycle bins, temporary folders and files and left over install files.

9. A method for automatically cloning a second storage device from a first storage device by excluding all non-critical for booting system related folders and/or files including all user library folders and files from the cloning process such that the resulting cloned storage device can fit on a substantially smaller storage device, the method comprising:
computing the used capacity of the first storage device excluding system related folders and/or files not critical to the booting of the cloned storage device and all user library folders, subfolders and/or files and computing the capacity of the second storage device;
determining if the used capacity of the first storage device after the excluded folders and/or files is smaller than the available capacity of the second storage device and if the used capacity of the first storage device is smaller than the available capacity of the second storage device,
copying all of the system related folders and files less those system related excluded folders and files and master boot record and its associated sectors from the first storage device to the second storage device rendering the second storage device bootable;
if the computed used capacity of the first storage device is larger than the available capacity of the second storage device exiting the cloning process.
